(19) United States
(12) Patent Application Publication
(10) Pub. No.: US 2010/0279017 A1
(43) Pub. Date: Nov. 4, 2010

(54) DEVICE AND METHOD FOR COATING A SURFACE

(75) Inventor: Jens Eckstein, Dachau (DE)

Correspondence Address: SCHOPPE, ZIMMERMANN , STOCKELER & ZINKLER;C/O KEATING & BENNETT, LLP, 1800 Alexander Bell Drive, SUITE 200, Reston, VA, 20191, US

(73) Assignee: STANGL SEMICONDUCTOR EQUIPMENT AG, Fuerstenfeldbruck (DE)

(21) Appl. No.: 12/741,658

(22) PCT Filed: Nov. 6, 2008
(86) PCT No.: PCT/EP08/09379

§ 371 Date: Jul. 7, 2010

(30) Foreign Application Priority Data
Nov. 7, 2007 (DE) 102007053065.1
Feb. 5, 2008 (DE) 102008007570.1

(51) Int. Cl. B05D 3/02; B05C 9/14

(52) U.S. Cl. 427/372.2; 118/60

(57) ABSTRACT

A device for coating a product includes a provider for providing a liquid containing reagents necessitated for coating. Additionally, the device comprises a transporter for contacting the surface of the product to be coated with the liquid and passing same by the liquid such that the surface to be coated remains in contact with the liquid for a predetermined period of time so as to effect coating thereof.

### BACKGROUND OF THE INVENTION

Embodiments of the present invention relate to a device and a method for coating a surface of a product and, for example, how the surface of a continuously transported product or material can be coated.

Coating materials is frequently carried out, for example, in the field of semiconductor production and structuring. Hereby, it is frequently necessitated to be able to adjust a layer thickness across the whole area of the surface to be coated in a manner that is as homogenous as possible. In the case of elements existing in individual pieces, coating can be easily made if, for example, a wafer, a foil or a pane of glass or a product to be coated is dipped entirely into a volume suitable for coating, which is filled at least partly with the coating material, or is brought into contact with the same on one or both sides. The coating itself can thereby be accelerated or triggered by different mechanisms. It is, for example, possible to add an activating chemical only when the surface to be coated is already in contact with the coating material. Chemicals having a short reaction time, i.e. that react quickly, can, for example, be mixed with each other only in the reaction volume itself or immediately prior to introducing them into the same or only on the surface of the product to be coated.

Additionally, in several fields of coating technology and semiconductor technology it is necessitated to coat large contiguous surfaces. This can, for example, be the case in flexible substrates, as they are used, among others, in the production of organic semiconductors. Also in the field of solar technology, where high production costs of solar cells frequently exceed obtainable yields, it can be desirable to provide a technology allowing the coating of foils, band-shaped substrates or metal foils, so that large areas can be coated in a short period of time for obtaining a significant reduction in production costs.

### SUMMARY

According to an embodiment, a device for coating a surface of a product, may have means for providing a liquid having reagents necessitated for coating; and transport means configured to effect a relative movement between a surface of the product to be coated and the liquid while the surface of the product to be coated is in contact with the liquid such that the surface to be coated remains in contact with the liquid for a predetermined period of time so as to cause coating thereof, the transport means being configured to effect the relative movement tangentially to the surface to be coated, continuously and without reversing the direction of movement; heating means implemented to heat the surface to be coated to a temperature where reaction of the reagents by which coating is effected takes place, while the surface of the product to be coated is in contact with the liquid; the heating means being implemented to heat a rotating transport roller of the transporter arranged on the side of the product opposite to the liquid in order to effect the relative motion, or to heat a hot-plate arranged on the side of the product opposite to the liquid such that the product rests on the hot-plate; and wherein the device is implemented to coat a product on one side.

According to another embodiment, a method for one-sided coating of a surface of a band-shaped product may have the steps of: providing a liquid having reagents necessitated for coating; and contacting the product and the liquid and generating a relative movement between a surface of the product to be coated and the liquid, while the surface of the product to be coated is contacted by the liquid such that the surface to be coated remains in contact with the liquid for a predetermined period of time so as to effect coating thereof, the relative movement being effected tangentially to the surface to be coated, continuously and without reversing the direction of movement, and while the surface of the product to be heated is contacted by the liquid, heating the surface to be coated to a temperature where the reagents by which coating is effected react, by heating a rotating transport roller arranged on the side of the product opposite to the liquid in order to effect the relative motion, or by heating a hot-plate arranged on the side of the product opposite to the liquid such that the product rests on the hot-plate.

According to another embodiment, a system for coating a web-shaped product may have: an inventive device for coating a surface of a product; a storage roller for storing the product to be coated and for providing the product to the transport means; and a withdrawal roller for receiving the coated product from the transport means and for storing the coated product.

In several embodiments of the present invention, coating a surface of a product is enabled by using a transport means bringing the surface of the product to be coated in contact with a liquid having the reagents necessitated for coating and passing the same by the surface. By varying the operational parameters of the transport means, such as the feed per time unit, it can be achieved that the surface to be coated remains in contact with the liquid for a predetermined time in order to effect coating of the same.

By varying the reaction parameters, such as temperature and concentration of reagents, the reaction rate and, in combination therewith by varying the contact time between material and liquid, the layer thickness of the coating can be varied freely. In several embodiments of transport means, variation of the contact time can be obtained by simple adjustment of the operational parameters of the same.

In further embodiments of the invention, the product is passed by the liquid or through a liquid volume by the transport means in a continuous manner and without reversing the direction of movement, so that it is possible to perform coating of extensive, for example band-shaped, materials or products in a continuous manner and without interruption.

In further embodiments or systems for coating, these materials are provided or wound off from a storage roller in order to be received and wound up on a withdrawal roller after coating by means of the transport means or after passing the transport means. This allows large areas of web-shaped materials to be coated efficiently and without interruption.

Further embodiments comprise a drying means for drying the coated product, so that the liquid of the coating is completely dried before the coated product is withdrawn or wound up on a withdrawal roller, so that the quality of the coating is not decreased by possible mechanical influences after the actual coating process. Further embodiments of the invention have a heating means for heating the surface of the product to be coated and/or the liquid with possible chemical reagents, so that an endothermal reaction becomes possible or for varying the reaction rate. This allows, for example, enabling the chemical reaction triggering the coating or forming the coating material only in immediate contact with the surface, or increasing the reaction rate such that the layer thickness to be obtained by the coating is obtained in the given transport means, i.e. at the given feed velocity or relative velocity between the surface of the product and the liquid.

In several embodiments, the product to be transported is led through a liquid bath by means of a cylindrical roll, wherein the roll can optionally be heated. Thereby, the geometry of the transport means can be selected such that the product is coated either on one or two sides, i.e. comes into contact with the liquid on one or two sides. In further embodiments, the transport means is provided with sealing means, which allow spatial limitation of the surface region of the product brought in contact with the liquid. These can, for example, be sealing lips sealing the material against the liquid at the edge of a band-shaped material, so that coating of the material or the product occurs only in a central region centered on the symmetry axis of the band.

In several further embodiments of the invention, transport rollers guiding the product after coating or after the transport means are constructed such that the same generate a water foil on the surface of the transport roller so that any coating material not yet completely dried or hardened is not removed from the surface of the product to be coated by the transport roller, or the coating is not damaged. In several embodiments, the water stream can additionally be used for flushing any possibly existing contamination from the surface of the coated product and thereby possibly allowing contact-free transport at the same time.

Other elements, features, steps, characteristics and advantages of the present invention will become more apparent from the following detailed description of the preferred embodiments with reference to the attached drawings.

### BRIEF DESCRIPTION OF THE DRAWINGS

Embodiments of the present invention will be detailed subsequently referring to the appended drawings, in which:

FIG. 1 is an embodiment of a device for coating a surface of a product;

FIG. 2 is a further embodiment of a device for coating a surface;

FIG. 3 is a further embodiment of a device for coating a surface with a recycling cycle;

FIGS. 4a-4c is an embodiment for one-sided coating of a limited surface region of a band-shaped product;

FIGS. 5a, 5b is a further embodiment for coating a surface with linear feed of the product to be transported;

FIG. 6 is a further embodiment of a device for coating a surface with linear feed;

FIG. 7 is a further embodiment with a linear feed and heating option;

FIG. 8 is a further embodiment with a linear feed and sealing means for limiting the coated surface region;

FIG. 9 is a further embodiment with linear feed;

FIG. 10 is a further embodiment with linear feed for two-sided coating of a product;

FIG. 11 is a further embodiment for two-sided coating;

FIG. 12 is an embodiment of a method for coating a surface of a product;

FIG. 13 is an embodiment of a system for coating a web-shaped product; and

FIGS. 14a, b is an embodiment with web-shaped product to be coated.

### DETAILED DESCRIPTION OF THE INVENTION

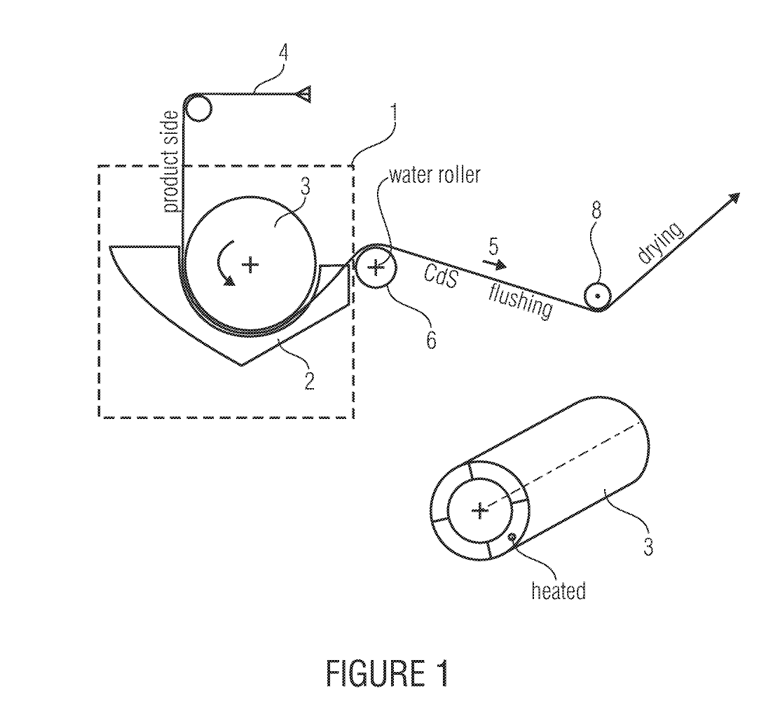

FIG. 1 shows an embodiment of a device for coating a surface of a product suitable for coating web-shaped material.

In FIG. 1, the device is illustrated schematically in a cutaway view. The device 1 has a transport means 3 for bringing the surface of a product 4 (for example a material band) into contact with a liquid and to pass the same by the liquid. Further, the device comprises a container 2 comprising the provided liquid, and a transport roller 3, by means of which the product to be coated is passed by the liquid within the container 2. In the case shown in FIG. 1, the product 4 to be coated is web-shaped, thus having a geometrical extension in a transport direction 5 exceeding the extension of the band perpendicular to the transport direction (the width of the band) by far. The product 4 to be coated can thereby, for example, be obtained from a roller by means of an unwinder and be supplied to the transport means 3, wherein the surface (the product side) to be coated is on the side facing away from the transport roller 3. By rotating the transport roller 3 (transport means), the product 4 is passed by the liquid or transported through the liquid volume located inside the container 2.

Hence, the product 4 to be coated is continuously moved tangentially to the surface to be coated (the product side) by the transport means 3, without any reversal of the direction of movement. This has the advantage that the material can be coated without interrupting the feed of the product, so that, for example, a roller-to-roller coating of web-shaped or flexible materials, such as foils or metal bands, is enabled.

In the case shown in FIG. 1, the product is transported in the transport direction 5 so that the same can, for example, be supplied to a downstream winding-on device receiving the coated product and winding the same up in a roller shape. In the embodiment of FIG. 1, a first redirecting roller 6 and a second redirecting roller 8, which serve for guiding the web-shaped product, follow the transport means 1. In several embodiments, the first and/or the second redirecting roller 6 or 8 can be implemented for providing a water film on the surface of the roller. This can take place, for example, in that the guiding roller has a central bore into which water is guided with a predetermined pressure, so that the same flows through a plurality of radial bores in the guiding roller 6 to the external perimeter of the guiding roller 6 and forms a water film between the product 4 to be transported and the guiding roller 6, which prevents the surface of the product to be coated from coming into direct mechanical contact with the metallic or fixed parts of the guiding roller 6. This has the advantage that, even when a chemical reaction or a coating reaction, or hardening of the material or the liquid used for coating the material has not been completely accomplished, deterioration of the coating with regard to quality due to mechanical contact with rigid or solid bodies can be avoided.

In that respect, it has to be noted that coating of foils or metals or similar band-shaped materials is possible both in a one-sided and a two-sided manner by means of the embodiment shown in FIG. 1, depending on whether the product 4 rests in a fluidically sealed manner on the transport roller 3 or whether sealing measures have been taken between the web-shaped product 4 and the transport roller 3 preventing the liquid from reaching the side opposite the side of the material to be coated (the product side). Regarding the material characteristics of the product to be coated, there are no limitations. In this manner, a foil to be coated or a band-shaped material can consist, for example, of plastic or of magnetic or non-magnetic material.

In the case of one-sided coating, in some embodiments, the first guiding roller 6 is implemented for generating a water foil on its surface, so that the coated product side of the surface is not damaged. If the material or product 4 is coated on two sides, in several embodiments the second guiding roller 8 can also be implemented for guiding the product or the material on a water film.

In some embodiments, the feed velocity or the velocity with which the product is passed by the liquid is adjusted such that the desired coating thickness results. This can be performed by using both a previously specified design and also a regulation, such that the velocity of the transport can be reduced, for example, when after the coating, it is noted that the layer thickness is too thin. In several embodiments, the liquid is transported or circulated in counter-flow to the product to be coated, i.e. against the direction of movement of the product. In this case, it is ensured that the medium at the contact point is fresh.

By varying the velocity, the predetermined time in which the liquid comes into contact with the surface of the product to be coated is varied. In several further embodiments, either the transport roller 3 or the liquid or the container 2, respectively, or both can be heated in the above-mentioned means, so that a reaction rate of a chemical used for coating in increased or that an endothermal reaction is made possible.

An appropriate adjustment of the temperature or the transport velocity, respectively, allows selecting the obtainable layer thicknesses or setting the coating velocity in an appropriate manner. An example of possible heating of the transport roller 3 is shown in FIG. 1 at the bottom in the perspective view of a transport roller 3, which is formed as a hollow cylinder, through the inside of which liquid used for heating can flow. This can, for example, be oil or water, wherein in several embodiments a liquid with high heating capacity is used to ensure uniform heating.

As long as, for the coating or the chemical reaction which is to take place on the surface of the product to be coated, a maximum relative velocity between the product to be coated and the liquid is not to be exceeded since the particles used for coating can otherwise no longer stick to the surface, the perimeter of the transport roller 3 can be varied at a constant rotation velocity or the rotation velocity can be reduced with a constant perimeter. For ensuring good exchange of the liquid, in several embodiments the liquid is transported against the rotation direction.

In addition to the above-described heating measures, the transport roller 3 can, in several embodiments, also be heated electrically. Further, the roller or the product can also be heated by means of radiation, for example using infrared radiation. The material of the transport roller 3 can be varied depending on the product to be transported or the desired heating capacity. For example, metals or metal alloys, glass or crystalline substances can be used.

As has already been mentioned above, by appropriate adaptation of the diameter of the drum and the rotation velocity, the system can be adapted to the respectively given boundary conditions. In alternative embodiments, this also leads to success even when the drum does not rotate but merely serves for defining the path of the product. This can, for example, be the case when the product slides across the drum 3 or floats on the same on a cushion of air or liquid.

If, for example, a maximum relative velocity between the product to be coated and the liquid of 1 mm/s is predetermined and if the overall coating period is to be 7 minutes, the drum diameter can be estimated as follows. Thereby, as a working hypothesis, it is assumed that the liquid level within the container 2 is selected such that 40% of the perimeter of the transport roller 3 is within the liquid. When a relative velocity of 1 mm/s and a 7 minutes' coating period is assumed, a path of 420 mm to be covered within the liquid results. In addition, the rotation frequency of the same results immediately from the tangential velocity of 1 mm/s and the diameter of the drum to be calculated as follows. The perimeter of the drum, which is within the liquid, has to be 420 mm. Since the following applies for the radius r of the drum:

$$r = \frac{U}{2 \cdot π}$$

and, in addition, 40% of the perimeter corresponds to 420 mm (from which a length of 1,050 mm results for the full perimeter) the necessitated radius of the transport roller 3 results in:

$$r = \frac{1 , 050 mm}{2 \cdot π} 167 mm$$

Hence, a drum with a diameter of 334 mm fulfils the above requested conditions, wherein the same rotates with a frequency immediately given by the maximum relative velocity of 1 mm/s and the radius of the drum.

If a relative velocity of 2 mm/s is necessitated in a coating period of 7 minutes, using the above considerations a drum with twice the diameter, i.e. d=668 mm, would result. At such a relative velocity, a relative velocity of 120 mm/min would result. Consequently, 840 mm of path are covered within the liquid or in contact with the liquid, in 7 minutes coating time, which can be achieved by means of a drum of the above dimensions.

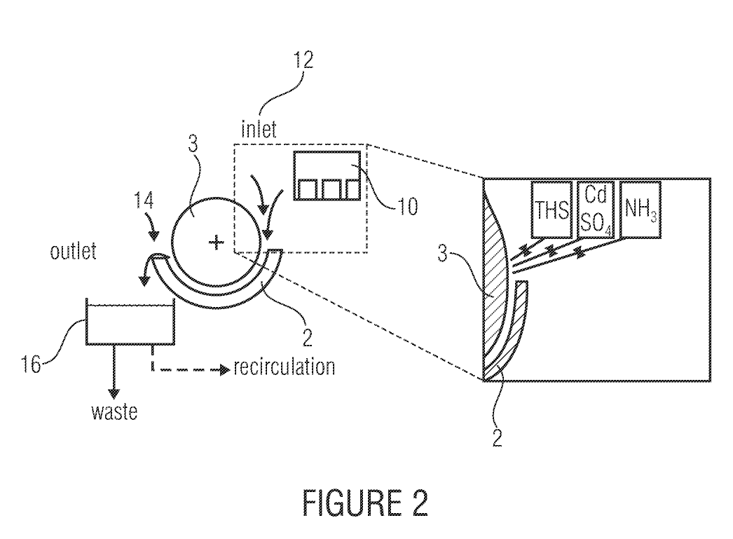

FIG. 2 shows a further embodiment of a device for coating a surface, wherein, additionally, a mixer 10 is shown schematically, which supplies the liquid or the chemicals to the means for providing the liquid (i.e. the container 2) at the introduction position 12. At a discharge position 14, which is formed in the shape of an overflow, the liquid leaves the container 2 in order to be collected in a collecting basin 16. Thereby, according to one alternative, the liquid within the collecting basin 16 can be treated as waste or, as will be discussed in more detail below, supplied to recycling.

The mixer 10 can store, for example, a liquid consisting of several reagents, in an already premixed state, for supplying the same to the inlet, i.e. the introduction position 12, with a predetermined dosage velocity or amount. In other embodiments where a possible early reaction of the reagents in the liquid is not desired, the mixer 10 can store the individual reagents separately and mix them only immediately prior to supplying the same to the introduction position 12. Basically, mixing can also be performed within the container 2, so that in further embodiments the mixer 10 supplies the individual reagents separately to the introduction position. If, for example, a foil or a band-shaped material is to be coated with CdS, ZnS or alternative materials (buffers), as is desirable in the production of thin-film solar cells, the following reagents can be included in the liquid: CdSO₄, THS and NH₃. The same react chemically above a reaction temperature, so that a layer of CdS is deposited on the surface of the product 4. For the mentioned chemical components, this reaction temperature is 53° C.

In order to avoid early or premature reaction and hence unnecessary chemical consumption, these chemicals can be stored separately, wherein storage can take place both above the reaction temperature of 53° C. and below the same. If the storage is below the reaction temperature, in several embodiments the reagents can also be already mixed. Also, parts can be stored already in a premixed manner, for example CdSO₄ and NH₃, wherein their storage can be cold or warm, as long as THS is added and dosed separately.

Alternatively and/or additionally, as described above, the transport roller 3 can be heated in order to cause a reaction particularly on the surface of the transport roller. This can lead to a reduction of chemical consumption when in the other volume a reaction of the chemicals does not take place, or only at reduced velocity, since the reagent temperature is merely exceeded in the close vicinity of the roller.

In the cutout enlargement shown in FIG. 2, again, the option of individual dosage is illustrated schematically, where the different chemicals (in the illustrated example THS, CdSO₄ and NH₃) are stored individually and supplied to the introduction position 12.

As can be seen in the cutout enlargement, the chemicals are stored individually and supplied to the container 2 at the introduction position 12 by means of appropriate dosage methods. Transporting the chemicals or liquids can take place, for example, by means of impeller or dosage pumps. Alternatively, the tank can also be pressurized, so that dosed transport takes place by means of clocked opening and closing of a valve. Further, a mixer can be positioned in the transport path or in front of the introduction position 12, mixing the individual components, for example under the influence of gravity. Alternatively, chemical introduction can be regulated by a floater determining the amount of liquid removed from the storage basin, so that the same can basically also be discharged under the influence of gravity, as long as the floater level regulates a valve.

Due to the low chemical consumption, the chemical in the gap itself can also be heated to processing temperature immediately after entry into the (reactor) gap.

In the embodiment shown in FIG. 2, the container 2 is formed such that the same has an inner surface, which is opposite to the surface of the product 4 to be coated, and whose outline is adapted to the outline of the surface to be coated. In the illustrated case, the inner outline of the container 2 is in the shape of a circular arc, so that a gap of a constant width results between the transport roller 3 and the inner wall of the container. A low width of this gap has the effect that merely a low mixed amount of chemicals has to be stored. This has the effect that the waste, which is proportional to the volume of the already mixed chemical, can be minimized. In addition, the low liquid volume can be easily heated, so that, if applicable, merely heating of the transport roller 3 is necessitated. The volume where the chemical reaction takes place is generally referred to as a reactor. If the reactor volume is minimized as far as possible, this will have, in summary, the effect that merely low media consumption takes place, wherein the medium also only cools off slightly, so that the reactor reaction (the gap reaction) can take place efficiently within the gap.

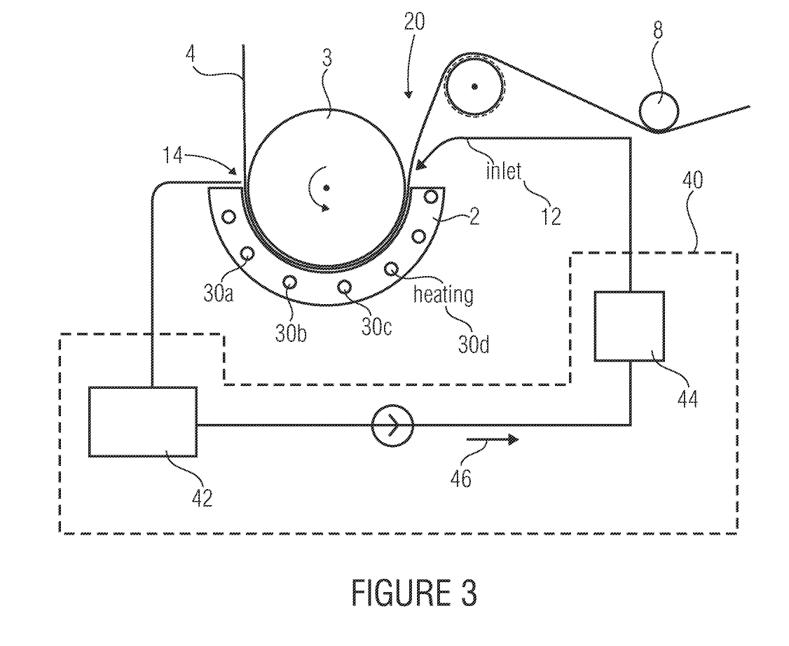

FIG. 3 shows a further embodiment of a device for coating a surface where the reaction or coating takes place in a gap 20 between the product 4 to be coated and an outline of the container 2. The other outlined components of the device have already been discussed based on previous embodiments, so that elements provided with the same reference numerals will not be discussed below for reasons of efficiency. The embodiment shown in FIG. 3 differs from the embodiment described in FIG. 2 by the fact that the same has a heating means 30 consisting of several heating elements 30a-30d for heating the container 2, and for ensuring that the liquid or the mixture of reagents is heated to a temperature at which the chemical reaction desired for coating can take place. Further, FIG. 3 has a means for circulating the liquid 40 disposed between the discharge position 14 and the introduction position 12 for reusing the liquid leaving the discharge position, i.e. the overflow, at least partly.

The means for circulating the liquid 40 has a cooling means 42 and a filter means 44 which are sequentially arranged along a return direction 46. The cooling means serves for cooling the chemical or reagent mixture for bringing the same again below a temperature necessitated for reaction, so that no chemical consumption takes place during recirculation. Material that has already reacted, for example crystallized material, is removed from the recirculated or recycled chemical or liquid flow by the filter 40.

Hence, in addition to minimizing the chemical consumption by reducing the reactor volume, it is possible to reduce the overall consumption of chemicals or liquids by recycling and reusing the liquid. In the embodiment described in FIG. 3, in several embodiments, the chemical or liquid can be permanently cooled and recirculated. With crystalline or solid components in the recirculated liquid mixture (for example CdS), the liquid can be purified by means of a centrifuge, for depositing the CdS particles/colloids. Of course, as an alternative to the embodiment shown in FIG. 3, reactor heating can also be performed from inside, wherein the heating elements 30a-30d can, for example, also be integrated in the container 2. Additionally and/or alternatively, as described in the above embodiments, the transport roller 3 can be heated.

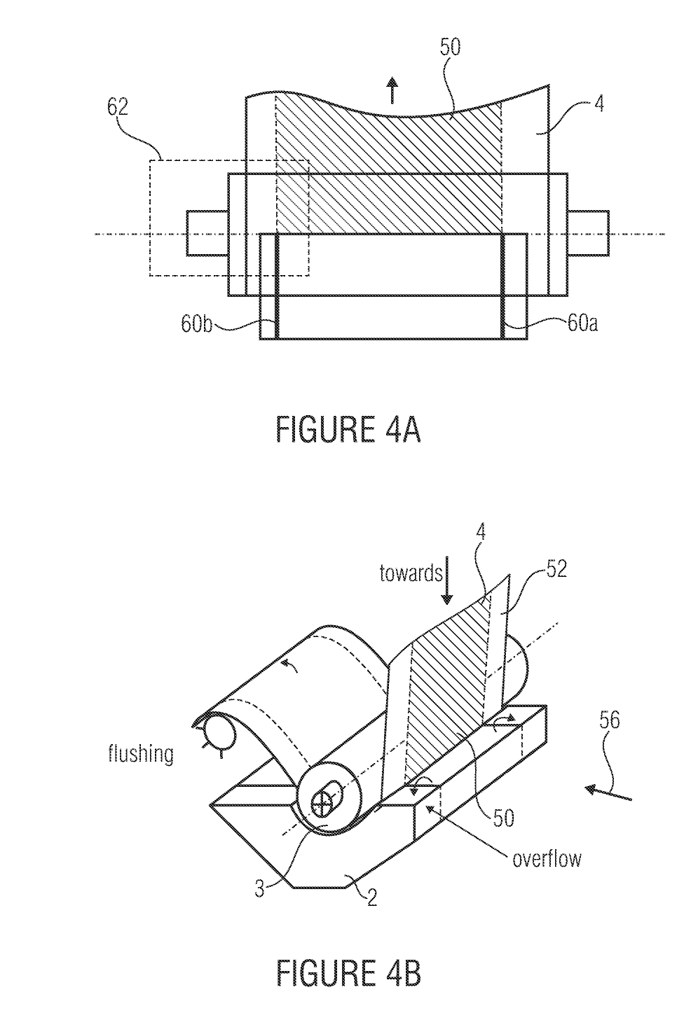

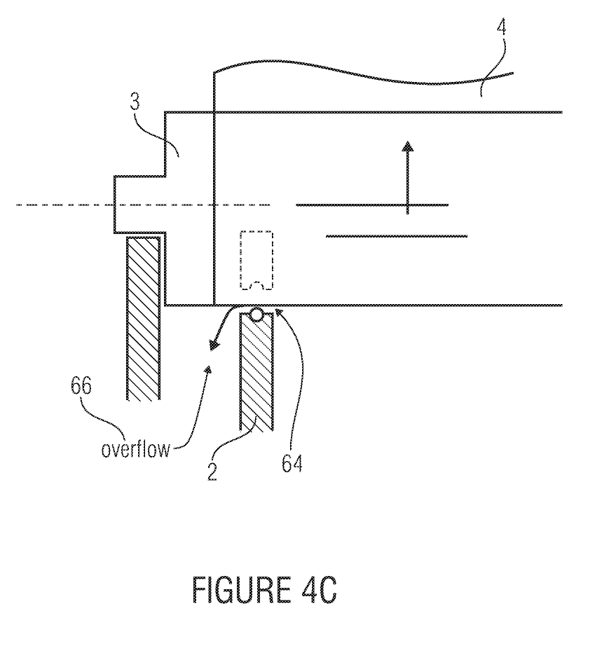

FIGS. 4a-4c show an embodiment of the present invention in different views, wherein the surface region of the product 4 brought in contact with the liquid is limited by providing sealing elements 64 separating the liquid from the surface region of the product 4 not to be brought into contact. Thereby, FIG. 4a shows a view of the embodiment, which is illustrated in a perspective view in FIG. 4b. Further, FIG. 4c shows a cutout enlargement, which allows the sealing mechanisms to be seen, by means of which the surface region brought into contact with the liquid can be limited.

The embodiment shown in FIGS. 4a-4c is based on the embodiments already discussed based on the above figures, so that in the following discussion merely changes with regard to these embodiments will be explained. The product 4 to be coated in FIG. 4 will be transported or moved such that it has a central region 50 as well as an edge region 52, wherein merely the central region 50 is brought into contact with the liquid. Hence, the central region 50 is that surface region of the product 4 that is coated. The liquid is within the container 2, within which the transport roller 3 proceeds. For ensuring that the liquid merely comes into contact with the product 4 in the central region 50, sealing is provided for sealing off the product 4 or the foil 4 against the container 2.

In the view of the embodiment of FIG. 4b illustrated in a view direction 56 in FIG. 4, it is obvious that the seals mounted at sealing positions 60a and 60b divide the product 4 or the foil to be coated into the central region 50 and the edge region 52. In the central region 50, the liquid is brought into contact with the surface of the product 4, whereas in the edge region 52, the surface of the product is not brought into contact with the liquid or chemical mixture. In the cutout enlargement of the region 62, framed in FIG. 4a, which is illustrated in FIG. 4c, a possible form of sealing is shown exemplarily.

Thereby, a sealing means 64 is mounted between the product 4 running on the transport roller 3 and the inner volume of the container 2, one side wall of which is illustrated schematically, which prevents free exit of the liquid from inside the container 2. The sealing can be carried out, for example, by means of lip sealing of flexible materials, such as rubber, CPDM or silicon. Alternatively, sealing can be accomplished with any other sealing means, for example via a flow of compressed air whose flow velocity is so large that discharge of large amounts of liquid can be prevented. In alternative embodiments, the fitting, i.e. the distance between the transport roller and the container can be accomplished in such an exact manner that, when the foil is present, the resulting gap width is so small that discharge of liquid is almost completely prevented. Liquid that is still discharged can, for example, be collected in an overflow 66 for supplying the same to recycling, if applicable. Further embodiments can use a slip ring or a slip ring seal of plastic or similar materials. When using plastic, the whole device can be flushed and cleaned with acidic materials, such as with HCl.

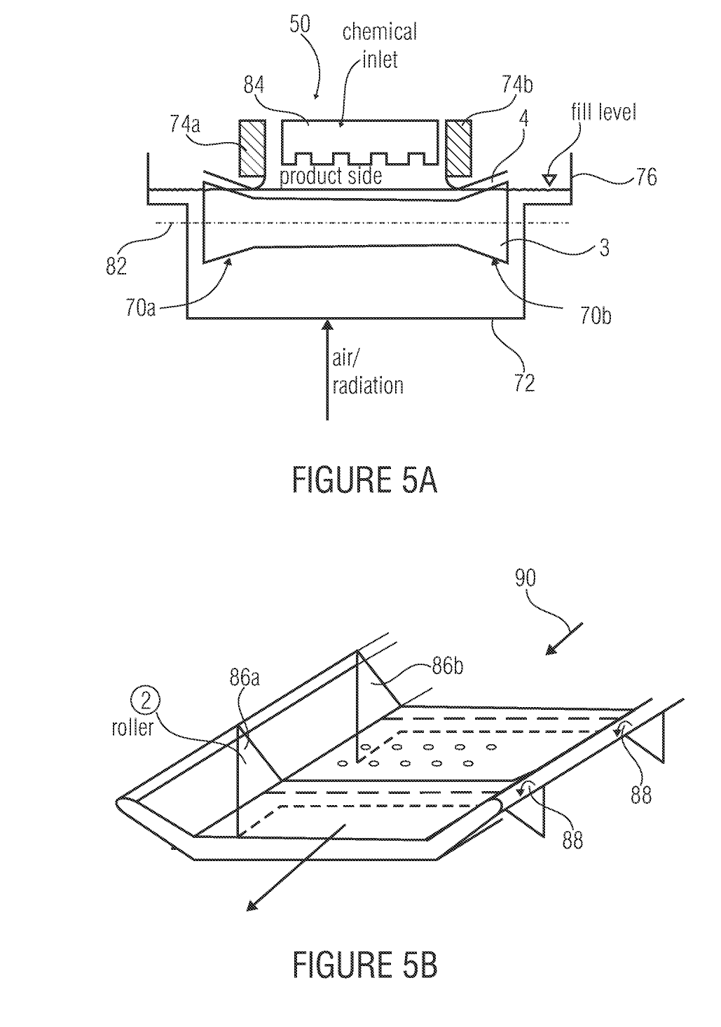

The embodiments of the invention shown in FIGS. 5a and 5b each show devices for coating a surface using linear feed, wherein the product 4 is moved in an approximately planar way relative to the liquid so that even non-flexible materials or materials of low flexibility may be coated on one or two sides. In the embodiment schematically shown in a sectional view in FIG. 5a, the transport means comprises a transport roller 3 on which the product 4 to be coated runs and which deviates from an ideal cylindrical geometry and comprises an increasing diameter at its outer edge regions 70a, 70b. Thus, the material from the transport roller 3 is guided in the shape of a channel. The transport roller 3 in the embodiment shown in FIG. 5a is located partly within a heating volume 72 which can be heated using a suitable heating method (exemplarily using hot air or (infrared) radiation). The surface to be coated or product side of the product 4 is facing away from the transport roller 3 and is contacted by the liquid or chemical mixture in a central region 50 and moved and/or passed by relative to same using the rotating transport roller 3. The embodiment shown in FIG. 5a is suitable for one-sided coating of a product or band-shaped material, wherein the chemicals or liquid may be added or added and mixed, as is described in one of the preceding embodiments. The embodiment additionally comprises sealing agents 74a and 74b in order to limit the surface region of the product 4, which is contacted by the liquid. Thus, in the embodiment shown in FIG. 5a, the liquid contacts only the central region 50.

In some alternative embodiments, the entire apparatus is additionally tilted around the axis 82 so that, under the influence of gravity, the liquid on the surface to be coated in the central region 50 flows over the surface so that both the liquid and the product 4 move. In order to achieve a constant flow rate of the liquid or chemicals, optionally a flow interferer 84 which is arranged within the means for providing the liquid, i.e. within the volume limited by the sealing agents 74a and 74b, may be used.

Depending on the demands on the apparatus, the flow direction of the liquid may thus be parallel or anti-parallel to the direction of feed or direction of movement of the product or foil 4.

FIG. 5b shows a perspective view of a potential implementation of the transport means 3 of FIG. 5a. In the example shown, it consists of two rollers 86a and 86b which rotate in a rotational direction 88 and thus move the product in a direction of transport 90 so that same can be coated when the liquid used for coating or the chemical mixture used for coating is located within the channel formed by the shape of the transport rollers 86a and 86b. Additionally, transport may be supported using an air cushion and/or a heater may be implemented when the air is to be heated.

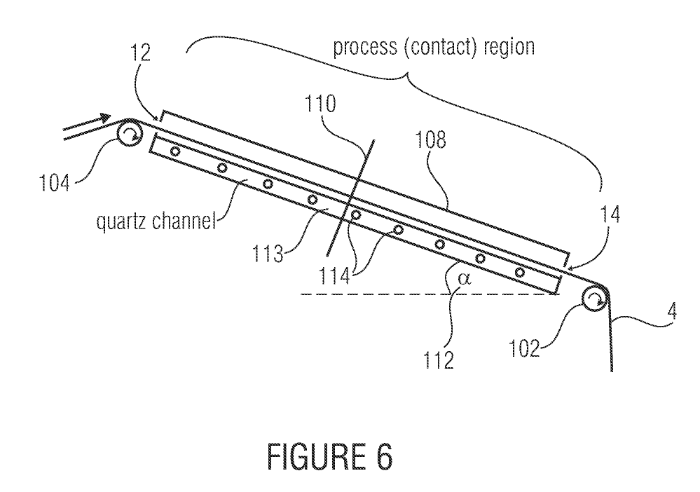

FIG. 6 shows another embodiment of the invention using linear feed of the product 4 which is guided through a process distance 108 serving to provide the liquid, i.e. within which the liquid used for coating is located, using two guiding rollers 102 and 104. In the introduction position 12, the chemicals or the liquid are introduced, leaving the means 108 at the discharge position 14, i.e. at an outlet.

In the sectional view of another embodiment using linear feed, shown in FIG. 6, an angle 112 (α) between the horizontal and the apparatus or process region may be varied in order to vary the relative velocity between the liquid or chemical mixture and the product to be coated. Thus, a sealing measure may be provided on the input side 12 in order to prevent unwanted discharge of chemicals in a direction opposite to the direction of movement of the product to be moved. This may exemplarily be achieved using an air blade or using flexible sealings. Within the process distance 108, the product 4 to be transported may exemplarily rest on a “hot plate” 113 or be guided by same such that the product may additionally be heated. In some embodiments, the hot plate is heated. This may exemplarily be achieved by a heated liquid circulating in channels 114 in the hot plate 113. In further embodiments, a gas flows to the bottom of the product 4 to be guided through bores in the hot plate so that the product is guided through the process distance 108 floating on an air cushion. In some embodiments, the assembly shown in FIG. 6 or the process distance is rotatable only in the direction of the angle 112. In further embodiments, the process distance 108 may be moved in all spatial directions so that, when driven appropriately, a wobble movement ensuring uniform distribution of the chemicals on the surface of the product to be coated is generated. In particular the coating homogeneity can be improved by this. In further embodiments, additional intermixing means ensuring that the mixture of chemicals remains homogenously mixed at all times are provided, the result being uniform coating. In some embodiments of the present invention, this is achieved using one or several ultrasonic transmitters radiating an ultrasonic signal into the liquid such that molecular movement within the liquid is boosted and thus the homogeneity of intermixing is improved.

Alternatively and/or additionally, as has already been discussed using some of the embodiments discussed before, the mixture of chemicals or liquid may be refreshed and/or regenerated permanently. This necessitates exchanging the liquid on the surface of the product to be transported. For this purpose, the liquid may be guided either in the direction of transport of the product or against the direction of transport of the product.

Like in the other embodiments, it is desirable for the materials used for forming elements which are in direct contact with the product to be transported to be resistant against chemicals used and temperatures occurring. Thus, the materials may be chosen approximately as desired and be adapted to the chemicals and/or process temperatures used. Exemplarily, the materials within the process distance 108 and/or the transport drum 3 of the previous embodiments may be made of quartz glass or stainless steel. Additional potential materials are plastics and metals or metal alloys. Advantageously, these can be cleaned using an acid without being destroyed.

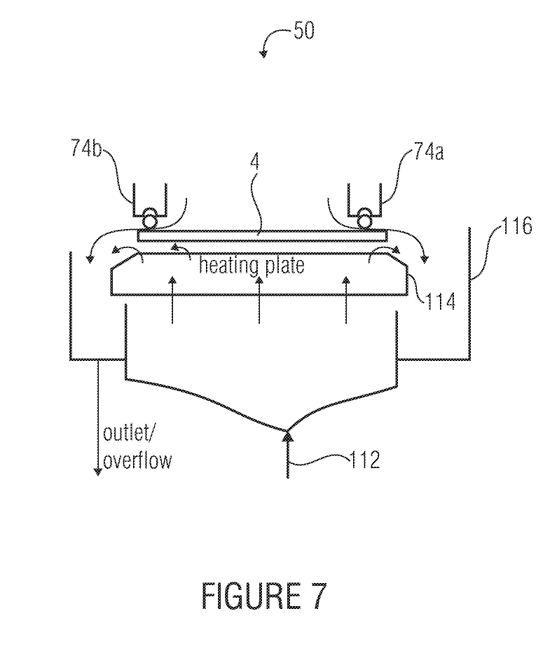

FIG. 7 shows a section through the device shown in FIG. 6 along a sectional plane 110. The product or material to be coated is contacted by a liquid flowing on the product 4 in a central region 50, sealing agents 74a and 74b preventing a significant portion of the liquid from leaving the central region 50. In some embodiments, an air cushion on which the product is transported is generated between a so-called “hot plate” 114 and the product. In further embodiments of the invention, the “hot plate” 114 located in the air flow which is provided with bores and is made of a solid material is heated so that the air is heated by the “hot plate” 114 and, additionally, the bores allow an air film to form between the hot plate 114 and the product 4. When using the hot plate 114, the product 4 can be prevented from bending and it can be ensured that the temperature is approximately constant when a material which exhibits high heat capacity is used for the hot plate. A mixture of chemical which may be discharged via the sealing agents 74a and 74b and/or liquid discharged can be collected using an overflow basin 116 and, maybe, recycled.

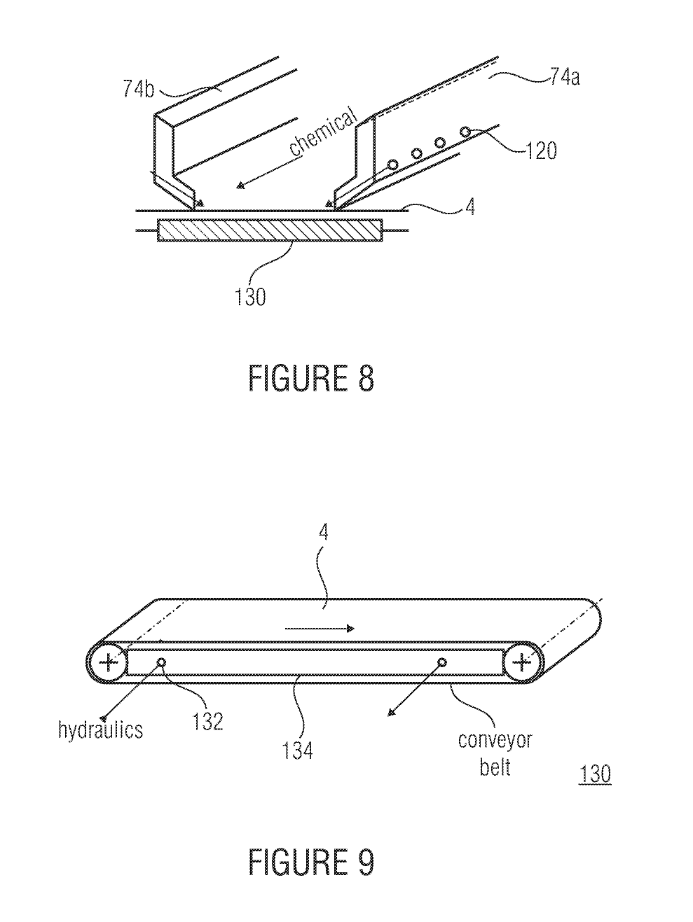

FIG. 8 shows an alternative embodiment using linear guiding of the product 4 wherein the sealing agents 74a and 74b are implemented such that the sealing effect can be achieved by an air flow. For this purpose, as is shown in FIG. 8, the side walls limiting the liquid volume may be provided with air bores 120 through which air or any other gas mixture used for sealing may flow. The flow rate of the air is to be selected to be appropriate in order to allow liquid and/or chemicals to be prevented from being discharged at the edges of the sealing elements 74a and 74b. A hot plate on which, as is schematically illustrated in FIG. 9, a conveyor belt may be located which in turn ensures transport of the product 4 to be coated, i.e. forms the transport means, may be used for heating the product 4 or the material to be coated.

FIG. 9 shows an embodiment of such a conveyor belt within which there is a hot plate 134 heated exemplarily using a liquid through liquid channels 132. There is an air cushion by means of which the product 4 is both heated and protected from mechanical damage and is pressed against the sealing agents 74a and 74b using a suitable pressure, located between the hot plate 134 and the product 4 to be transported, which in the present case is a band-shaped material.

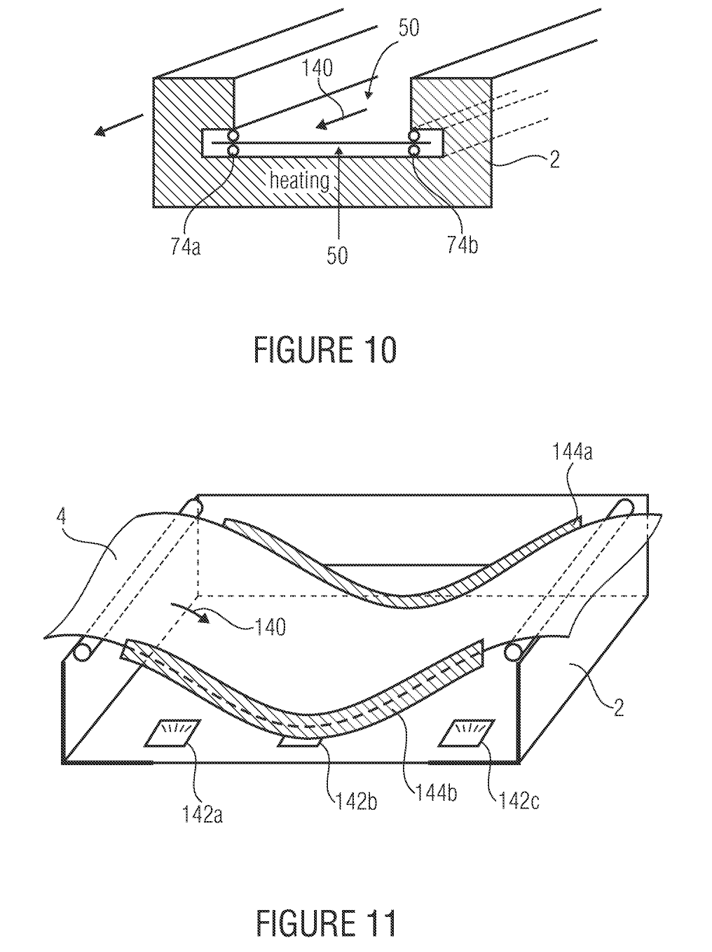

FIGS. 10 and 11 show embodiments using which two-sided coating of a product 4 becomes possible, the coated surface being limited using suitable sealing agents 74a and 74b so that the transport means will only contact the surface to be coated by the liquid in a central region 50.

In the embodiment shown in FIG. 10, the product or band-shaped material 4 is moved in a direction of movement 140 relative to the container 2 within which the liquid is located. The product 4 to be coated is guided both mechanically and sealed relative to the container 2 by sealing lips or sealing agents 74a and 74b so that a liquid in the central region 50 or a liquid for coating introduced there cannot leave this region so that only a limited surface region, namely the central region 50, on each of the two surface sides to be coated is coated and/or contacted by the liquid.

The case as shown in FIG. 11 in principle corresponds to the embodiment discussed in FIG. 10, wherein here, too, the direction of movement 140 is parallel to the longitudinal direction of the product or material. However, the travel path is not planar but curved, so that sealing the container 2 itself may be refrained from since the product is, along the direction of travel 140, at first immersed into the liquid volume within the container 2 and, due to the bent travel path, removed therefrom again.

This allows two-sided coating of materials which have the flexibility for the bent travel path without any complicated sealing measures.

FIG. 11 additionally shows optional ultrasonic transmitters 142a, 142b and 142c located within the process volume 2 and coupled thereto such that the ultrasonic powers may radiate onto the liquid. This serves for improving the homogeneity of intermixing of the individual liquid components, which results in an altogether more homogenous coating of the product and/or foil.

The product 4 to be coated is, in the case shown in FIG. 11, guided laterally by guiding rails 144a and 144b in order to be able to keep to the travel path.

One-sided coating of a product is, of course, also possible in FIG. 11, when the guiding rails 144a and 144b comprise the sealing measures already described before so that a liquid may exemplarily only be located above the product 4 to be coated, and only the top side of the product 4 is coated.

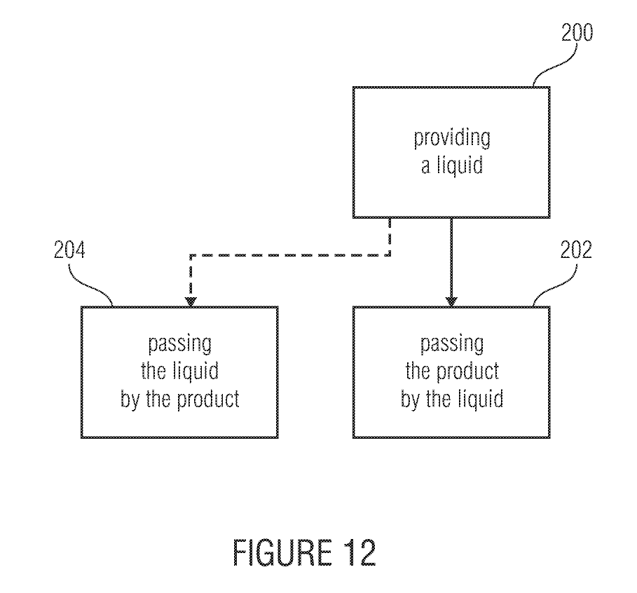

FIG. 12 shows an embodiment of a method for coating a surface of a product.

At first, in a step of providing 200, a liquid comprising the reagents necessitated for coating is provided. In a feeding step 202, a surface of the product to be coated is contacted by the liquid and passed by same so that the surface to be coated remains in contact with the liquid for a certain period of time.

It is ensured by means of passing by or the relative movement to the material or product to be coated that coating is continuous, even when materials of a very large dimension in a lateral direction, i.e. exemplarily band-shaped, are to be coated.

In an alternative method also illustrated in FIG. 12, after the step of providing 200, the liquid is passed by the stationary product in a step 204. This may exemplarily be used for coating non-continuous materials in a discrete operation, such as, for example, plastic plates or glass substrates or the like.

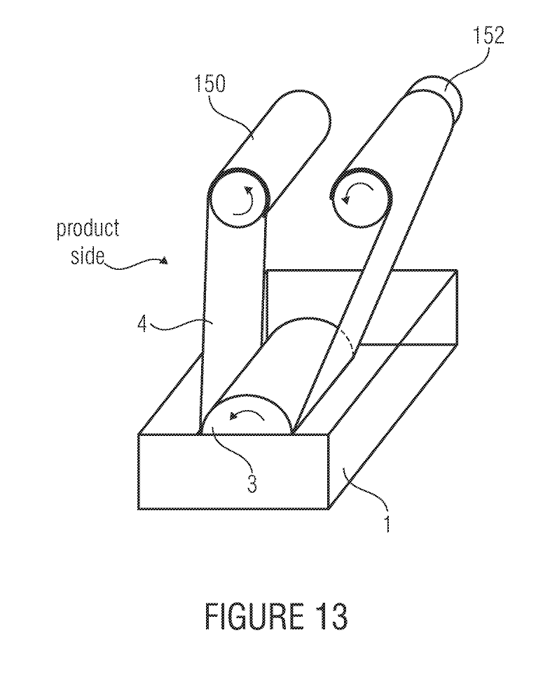

FIG. 13 shows an embodiment of a system for coating a web-shaped product. The system schematically illustrated in FIG. 13 includes a device for coating a surface 1 which may correspond to one of the embodiments discussed before in detail and which is suitable for coating a surface of a product 4. Additionally, the system comprises a storage roller 150 serving to store the product to be coated and provide the product to the transport means of the device for coating a product 1. In addition, the system comprises a withdrawal roller 152 for receiving the coated product from the transport means and storing the coated product. Since the inventive embodiments allow the devices for coating a surface of a product to pass the product continuously by the liquid to be coated, it is possible using the system shown in FIG. 13 to coat materials “from roller to roller”, i.e. coat same continuously without having to separate the material into discrete pieces. This increases the efficiency of coating and reduces the cost for coating significantly.

As is illustrated in FIG. 13, it is favorable to perform rolling the product to be coated on and off the storage roller 150 and the withdrawal roller 152, respectively, such that the side of the product 4 to be coated (the product side) faces the outside on the diameter of the rollers. Thus, additional time is obtained for the chemical drying on the surface of the product side 4 when same is rolled up on the withdrawal roller 152. Additionally, the product side, i.e. the side to be coated, is prevented from coming into mechanical contact with other guiding or redirecting rollers when a geometry as is shown in FIG. 13 is used.

Further potential redirection rollers are provided in further embodiments of the invention. When the redirecting rollers contact the product side, in some embodiments, they either comprise a device for providing a liquid film on the surface of the redirecting rollers or generating an air cushion on which the product may float. Thus, even when redirection in the direction of the product side is necessitated for reasons of process technology, the coated foil and/or the coated product is prevented from deteriorating in quality.

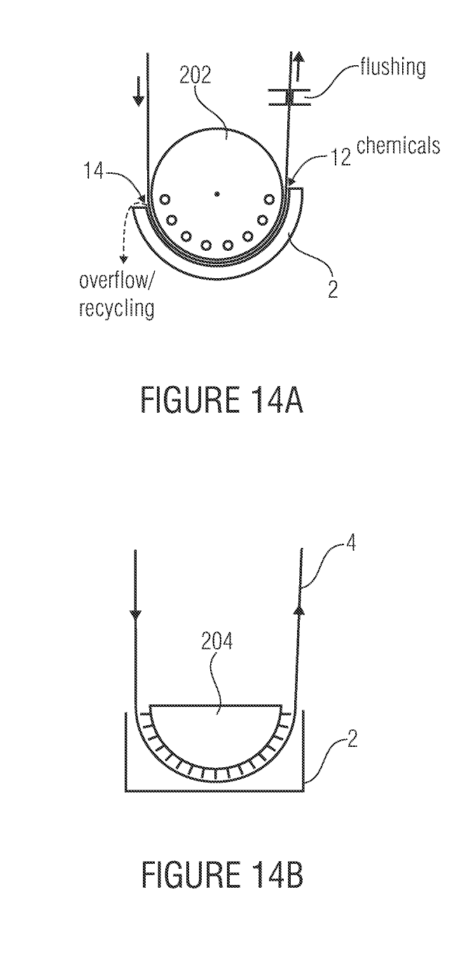

FIGS. 14a and 14b show another embodiment of the invention in which, as has already been discussed using FIGS. 1 to 4, the product 4 to be coated is guided around a cylindrical body 202 and around a part of a circular arc 204, respectively. As an alternative to the case as discussed in FIGS. 1 to 4 wherein the drum around which the product 4 is guided rotates, in the embodiments shown in FIGS. 14a and 14b, it is possible for the drum or part of the circular arc 204 to be arranged to be stationary. The remaining components correspond to the components already discussed in FIGS. 1 to 4 so that repeated discussion of these parts will be dispensed with here.

In other words, in the embodiments shown in FIGS. 14a and 14b, only the product 4 to be coated moves, whereas the drum 202 or the part of the circular arc 204 only serves for defining the path. In some embodiments, for ensuring a smooth relative movement of the product 4 to be coated to the drum 202 or part of the circular arc 204, both the drum 202 and the part of the circular arc 204 are provided with bores which allow a gas in the drum 202 and/or the part of the circular arc 204 at overpressure and/or a liquid within the components to exit, so that the product 4 to be coated may slide on gas or a liquid film. N₂ or compressed air may exemplarily be used here as the gas. When the gas or compressed air is additionally heated, the process rate on the surface of the product 4 to be coated can be increased or a process can only be allowed to take place if the latter is endothermal. In other words, the gas on the one hand functions as a transport means and on the other hand as a protection or back side protector for the surface of the product 4 to be coated facing away from the liquid. This allows one-sided coating without edge waste when the air pressure is so great that, at the edges of the product 4 to be coated, it prevents liquid from entering between the back side of the product to be coated and the drum 202 of part of the circular arc 204.

The geometries shown in FIGS. 14a and 14b for guiding the product 4 to be coated, however, are only exemplary. In further embodiments, different geometries of the elements defining the path (of the drum 202 of part of the circular arc 204 or the alternative embodiment) are used. In particular, elements of non-constant bending, such as, for example, ellipsoids or the like, may be used. In these embodiments, too, it is of advantage for the material from which the drum is formed to be temperature- and/or acid-resistant, so that the apparatus can be cleaned easily using an acid and/or is not damaged at continuously high process temperatures. As has already been discussed before, quartz glass or PTFE are examples of potential materials; these examples, however, should not be interpreted as an exclusive list.

Although mainly foils or flexible substrates were coated in the previous embodiments, applying the concept described is not limited to such materials. Rather, in particular with the embodiments using linear feed, non-flexible materials may also be coated, such as, for example, glass substrates, semiconductor substrates or other mono- or polycrystalline substrates or similar materials.

When fast drying or complete drying of the coating before winding up or processing the coated product cannot be achieved without external measures, further embodiments may additionally comprise drying means by means of which the coating on the surface of the product to be coated is dried before being processed further.

The geometries of the respective devices discussed using the previous embodiments are only to be interpreted as being exemplary and may be adapted to the circumstances as desired, as long it is ensured that the product to be coated is passed by the liquid and/or moved relative to the liquid.

Additionally, when redirecting rollers having a film of water or vacuum slides or components having air cushions are used, a band or product to be transported can be redirected in an almost unlimited manner without contacting the coating. When the rollers are pre-redirected or pressed against the product to be transported using a predetermined force, a band tension necessitated for an unlapped transport of a band-shaped material may additionally be maintained.

While this invention has been described in terms of several advantageous embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1-27. (canceled)

28. A device for coating a surface of a product, comprising:
a provider for providing a liquid comprising reagents necessitated for coating; and
a transporter implemented to effect a relative movement between a surface of the product to be coated and the liquid while the surface of the product to be coated is in contact with the liquid such that the surface to be coated remains in contact with the liquid for a predetermined period of time so as to cause coating thereof, the transporter further being implemented to effect the relative movement tangentially to the surface to be coated, continuously and without reversing the direction of movement;
a heater implemented to heat the surface to be coated to a temperature where reaction of the reagents by which coating is effected takes place, while the surface of the product to be coated is in contact with the liquid;
the heater being implemented
to heat a rotating transport roller of the transporter arranged on the side of the product opposite to the liquid in order to effect the relative motion, or
to heat a hot-plate arranged on the side of the product opposite to the liquid such that the product rests on the hot-plate; and
wherein the device is implemented to coat a product on one side.

29. The device in accordance with claim 28, further comprising sealing agents configured to limit the surface region of the product which is contacted by the liquid.

30. The device in accordance with claim 29, wherein the sealing agents comprise lip sealing, slip ring sealing or compressed air sealing.

31. The device in accordance with claim 28, wherein the provider for providing a liquid additionally comprises an intermixer in order to improve the homogeneity of the coating of the product.

32. The device in accordance with claim 31, wherein the intermixer comprises an ultrasonic transmitter coupled to the liquid.

33. The device in accordance with claim 28, wherein the provider for providing the liquid comprises a regenerator and/or a treater for regenerating and/or treating the liquid.

34. The device in accordance with claim 33, wherein the regenerator for regenerating the liquid comprises a circulator for circulating the liquid.

35. The device in accordance with claim 28, wherein the provider for providing the liquid comprises a container comprising an internal surface which is opposite the surface of the product to be coated and the outline of which is adapted to an outline of the surface of the product to be coated.

36. The device in accordance with claim 28, wherein the transporter is configured to guide the product, on a side of the product facing away from the liquid, on a gas or liquid transport layer.

37. The device in accordance with claim 28, wherein the provider for providing the liquid comprises an introduction position and a discharge position for the liquid spaced apart from the introduction position, the transporter being configured to transport the product through the provider for providing the liquid from the discharge position of the liquid to the introduction position.

38. The device in accordance with claim 28, comprising a guiding roller configured to provide a film of water on a surface thereof so as to guide a coated surface of the product.

39. The device in accordance with claim 28, wherein the transporter is configured to move the product at a constant rate, while the surface to be coated is contacted by the liquid.

40. The device in accordance with claim 28, further comprising a dryer for drying a coated product so that a coating of the surface to be coated is dried.

41. A method for one-sided coating a surface of a band-shaped product, comprising:
providing a liquid comprising reagents necessitated for coating; and
contacting the product and the liquid and generating a relative movement between a surface of the product to be coated and the liquid, while the surface of the product to be coated is contacted by the liquid such that the surface to be coated remains in contact with the liquid for a predetermined period of time so as to effect coating thereof, the relative movement being effected tangentially to the surface to be coated, continuously and without reversing the direction of movement, and
while the surface of the product to be heated is contacted by the liquid, heating the surface to be coated to a temperature where the reagents by which coating is effected react, by heating a rotating transport roller arranged on the side of the product opposite to the liquid in order to effect the relative motion, or by heating a hot-plate arranged on the side of the product opposite to the liquid such that the product rests on the hot-plate.

42. The method in accordance with claim 41, wherein the product is moved at a constant rate while the surface to be coated is in contact with the liquid.

43. The method in accordance with claim 41, further comprising limiting the surface region of the product which is contacted by the liquid.

44. The method in accordance with claim 41, wherein the product is moved through the provider for providing the liquid from an introduction position to a discharge position which is spaced apart from the introduction position.

45. The method in accordance with claim 41, wherein the product is a plastic foil or a metal foil.

46. The method in accordance with claim 41, wherein the surface of the product is coated by CdS.

47. A system for coating a web-shaped product, comprising:
a device for coating a surface of a product, comprising:
a provider for providing a liquid comprising reagents necessitated for coating; and
a transporter implemented to effect a relative movement between a surface of the product to be coated and the liquid while the surface of the product to be coated is in contact with the liquid such that the surface to be coated remains in contact with the liquid for a predetermined period of time so as to cause coating thereof, the transporter further being implemented to effect the relative movement tangentially to the surface to be coated, continuously and without reversing the direction of movement;
a heater implemented to heat the surface to be coated to a temperature where reaction of the reagents by which coating is effected takes place, while the surface of the product to be coated is in contact with the liquid;
the heater being implemented
to heat a rotating transport roller of the transport means arranged on the side of the product opposite to the liquid in order to effect the relative motion, or
to heat a hot-plate arranged on the side of the product opposite to the liquid such that the product rests on the hot-plate; and
wherein the device is implemented to coat a product on one side;
a storage roller for storing the product to be coated and for providing the product to the transporter; and
a withdrawal roller for receiving the coated product from the transporter and for storing the coated product.
